(19) United States
(12) Patent Application Publication
(10) Pub. No.: US 2015/0267107 A1
(43) Pub. Date: Sep. 24, 2015

(54) FULL FIELD STRAIN SENSORS USING MECHANOLUMINESCENCE MATERIALS

(71) Applicants: Jiahua Zhu, Cuyahoga Falls, OH (US); Gunjin Yun, Copley, OH (US)

(72) Inventors: Jiahua Zhu, Cuyahoga Falls, OH (US); Gunjin Yun, Copley, OH (US)

(21) Appl. No.: 14/664,092

(22) Filed: Mar. 20, 2015

Related U.S. Application Data
(60) Provisional application No. 61/968,100, filed on Mar. 20, 2014.
(60) Provisional application No. 61/968,089, filed on Mar. 20, 2014.

(51) Int. Cl. C09K 11/02; G01L 1/24; G01N 21/88; H01F 1/01

(52) U.S. Cl. CPC C09K 11/025; H01F 1/01; G01L 1/24; G01N 21/8803

(57) ABSTRACT

A sensor for visualizing stress includes a medium and a plurality of mechanoluminescence assemblies dispersed therein. A mechanoluminescence assembly can include a mechanoluminescence material and a coating material, where the mechanoluminescence material is at least partially coated with the coating material. A method of using the sensor can include applying the medium to a substrate and allowing the medium to form a solid film on the substrate. Methods of using the mechanoluminescence assemblies are also provided.

### CROSS-REFERENCE TO RELATED APPLICATION

This application claims priority to U.S. Provisional Patent Application No. 61/968,100 filed on Mar. 20, 2014, and U.S. Provisional Patent Application No. 61/968,089 filed on Mar. 20, 2014, the contents of which are incorporated herein by reference.

### FIELD OF THE INVENTION

The present invention generally relates to improved mechanoluminescence materials and associated methods of production and use. The present invention further relates to mechanoluminescence materials having a coating where the coating gives one or more additional properties to the coated assembly. The present invention further relates to mechanoluminescence materials that are coated with titanium dioxide and dispersed in a medium containing a dye. The present invention further relates to mechanoluminescence materials that are coated with magnetic nanoparticles.

### BACKGROUND OF THE INVENTION

It is previously known to use mechanoluminescence materials for the visualization of stress or crack distributions through the use of mechanically-induced light emission. Mechanoluminescence materials emit visual light in response to the mechanical strain and deformation that is subjected upon the materials.

Others have attempted to use the mechanical strain for the realization of a color change proportional to the strain. One such attempt includes the use of mechanophores and utilizing the opening and closing of the covalent bonds caused by mechanical straining However, this requires a large strain in order to induce color changes.

Another attempt has been the use of photonic materials, which induce structural color changes by Bragg's diffraction mechanism. However, photonic materials are limited by the poor quality of coloration and the particular wavelength bands that can be used.

Additionally, currently developed mechanoluminescence materials do not provide any information about the particular direction at which the mechanical strain is applied.

Thus, there is a need in the art for improved mechanoluminescence materials. There is also a need in the art for mechanoluminescence materials that visualize strain distribution by optical color changes. There is also a need in the art for mechanoluminescence materials that can be used to create direction-sensitive films.

### SUMMARY OF THE INVENTION

In a first embodiment, the present invention provides a method of using a mechanoluminescence assembly to observe stress distributions of a stressed substrate comprising the steps of providing a mechanoluminescence material; at least partially coating the mechanoluminescence material with a coating to form a mechanoluminescence assembly; dispersing a plurality of the mechanoluminescence assemblies within a medium that carries the plurality of assemblies; applying the medium to a substrate; allowing the medium to form a solid film on the substrate; and allowing the substrate to be stressed following the formation of the solid film.

In a second embodiment, the present invention provides a method as in the first embodiment, wherein the coating is titanium dioxide and the medium further comprises a dye.

In a third embodiment, the present invention provides a method as in either the first or second embodiment, further comprising the step of determining whether the substrate has undergone strain by analyzing whether the solid film has changed color.

In a fourth embodiment, the present invention provides a method as in any of the first through third embodiments, wherein the dye is an organic dye species.

In a fifth embodiment, the present invention provides a method as in any of the first through fourth embodiments, wherein the organic dye species is selected from the group consisting of methylene blue, methyl orange, methyl red, Alizarin yellow R, Janus green, Metanil yellow, Gentian violet, and combinations thereof.

In a sixth embodiment, the present invention provides a method as in any of the first through fifth embodiments, wherein the coating is a plurality of magnetic nanoparticles attached to the surface of the mechanoluminescence material.

In a seventh embodiment, the present invention provides a method as in any of the first through sixth embodiments, wherein the magnetic nanoparticles are selected from the group consisting of iron, nickel, cobalt, iron oxide, nickel oxide, cobalt oxide, and ferrite.

In an eighth embodiment, the present invention provides a method as in any of the first through seventh embodiments, further comprising the steps of subjecting the plurality of mechanoluminescence assemblies to a magnetic field having an H field and aligning the plurality of mechanoluminescence assemblies in the direction of the H field.

In a ninth embodiment, the present invention provides a sensor for visualizing stress comprising a medium and a plurality of mechanoluminescence assemblies dispersed therein, each mechanoluminescence assembly comprising a mechanoluminescence material and a coating material, the mechanoluminescence material being at least partially coated with the coating material.

In a tenth embodiment, the present invention provides a sensor as in the ninth embodiment, the medium containing the plurality of mechanoluminescence assemblies dispersed therein forming a dried solid film on a substrate.

In an eleventh embodiment, the present invention provides a sensor as in either the ninth or tenth embodiments, the coating being titanium dioxide and the medium further comprising a dye.

In a twelfth embodiment, the present invention provides a sensor as in any of the ninth through eleventh embodiments, the medium forming a dried film on a substrate and the medium capable of undergoing a color change when a strain is applied to the substrate.

In a thirteenth embodiment, the present invention provides a sensor as in any of the ninth through twelfth embodiments, the dye being an organic dye species.

In a fourteenth embodiment, the present invention provides a sensor as in any of the ninth through thirteenth embodiments, the organic dye species being selected from the group consisting of methylene blue, methyl orange, methyl red, Alizarin yellow R, Janus green, Metanil yellow, Gentian violet, and combinations thereof.

In a fifteenth embodiment, the present invention provides a sensor as in any of the ninth through fourteenth embodiments, the coating being a plurality of magnetic nanoparticles attached to the surface of the mechanoluminescence material.

In a sixteenth embodiment, the present invention provides a sensor as in any of the ninth through fifteenth embodiments, the magnetic nanoparticles being selected from the group consisting of iron, nickel, cobalt, iron oxide, nickel oxide, cobalt oxide, and ferrite.

In a seventeenth embodiment, the present invention provides a sensor as in any of the ninth through sixteenth embodiments, the medium forming a dried film on a substrate and the plurality of mechanoluminescence assemblies being alignable into a chained structure within the dried film, the chained structure being capable of having a direction of alignment that is parallel with an H field of a magnetic field.

In an eighteenth embodiment, the present invention provides a method of coating a mechanoluminescence material to be used for observing stress distributions of a stressed substrate comprising the steps of dispersing a mechanoluminescence material in a solvent; combining a precursor with the solvent containing the mechanoluminescence material to form a combined mixture; and heating the combined mixture to at least the decomposition temperature of the precursor to thereby form nucleation or nanoparticle growth on the surface of the mechanoluminescence material.

In a nineteenth embodiment, the present invention provides a method as in the eighteenth embodiment, the solvent being toluene and the precursor being iron pentacarbonyl.

In a twentieth embodiment, the present invention provides a method as in either the eighteenth or nineteenth embodiment, wherein the dispersion is performed by sonication, the method further comprising the step of heating the combined mixture to at least the boiling point of the solvent.

### BRIEF DESCRIPTION OF THE DRAWINGS

FIG. 1 is a front elevational view in partial cross section showing a mechanoluminescence material having a coating;

FIG. 2 is a front elevational view showing a mechanoluminescence material having a coating comprising a plurality of particles attached to the mechanoluminescence material;

FIG. 3 is a schematic showing a medium containing a mechanoluminescence material, the medium being applied to a substrate; and

FIG. 4 is a schematic showing a plurality of mechanoluminescence assemblies being aligned in the direction of an H field.

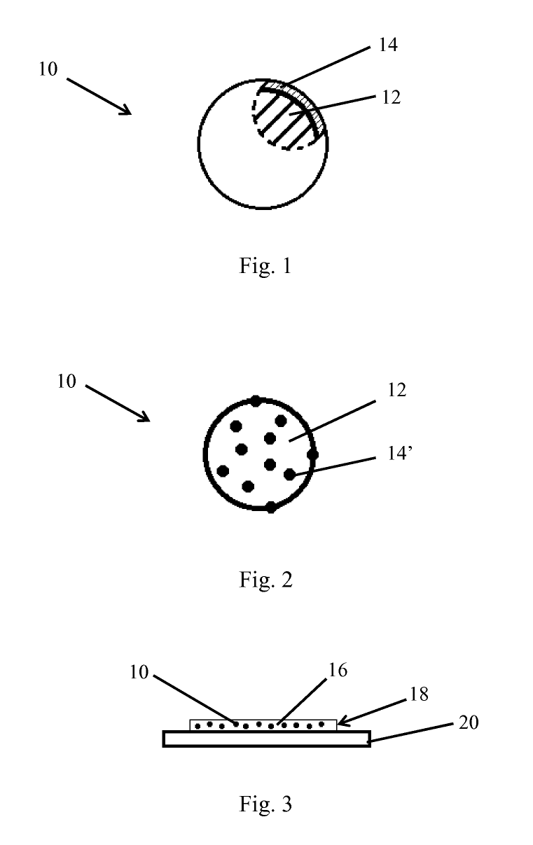

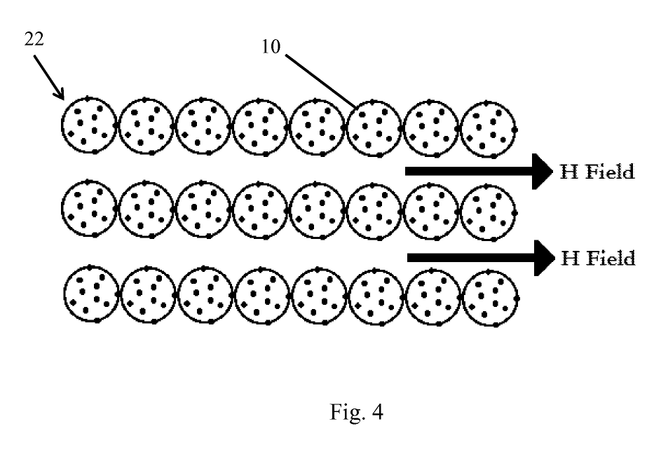

### DETAILED DESCRIPTION OF ILLUSTRATIVE EMBODIMENTS

A mechanoluminescence (ML) material assembly, generally indicated by the numeral 10, includes a mechanoluminescence material 12 and a coating 14, 14′ that at least partially coats ML material 12. A plurality of the assemblies 10 can be dispersed in a medium 16, to form a mechanoluminescence-material-containing medium, generally indicated by the numeral 18, which can be applied to a substrate 20. Assembly 10 has mechanoluminescence properties based on mechanoluminescence material 12. Further, coating 14, 14′ gives one or more additional properties to assembly 10 based on the particular coating 14, 14′ that is utilized.

ML material 12 can be said to form the core of assembly 10. In one or more embodiments, ML material 12 is a mechanoluminescence particle. In one or more embodiments, ML material 12 is a mechanoluminescent ceramic particle. Mechanoluminescence can be defined as light emission resulting from any mechanical action on a solid.

In one or more embodiments, ML material 12 is selected from the group consisting of ZnS:Mn; SrAl₂O₄:Eu (SAOE); SrAl₂O₄:Eu,Dy (SAOED); SrAl₂O₄:Ce; SrAl₂O₄:Ce,Ho; SrMgAl₆O₁₁:Eu; SrCaMgSi₂O₇:Eu; Sr₂MgSi₂O₇:Eu; Ca₂MgSi₂O₇:Eu,Dy; CaYAl₃O₇:Eu; Ca₂Al₂SiO₇:Ce; and combinations thereof.

ML material 12 must have a diameter that is less than the thickness of ML-containing medium 18 when it is applied to substrate 20. In one or more embodiments, a plurality of ML assemblies 10 has a mean diameter of from 200 nm or more to 40 microns or less. In one or more embodiments, a plurality of ML assemblies 10 has a mean diameter of from 1 μm or more to 60 μm or less. In one or more embodiments, a plurality of ML assemblies 10 has a mean diameter of from 2 μm or more to 20 μm or less. In one or more embodiments, a plurality of ML assemblies 10 has a maximum diameter of 60 μm or less. In one or more embodiments, a plurality of ML assemblies 10 has a maximum diameter of 20 μm or less.

ML material 12 can be characterized with respect to the wavelength of its excitation light. In one or more embodiments, this wavelength of excitation light is in a range from 400 nm or more to 1000 nm or less. In one or more embodiments, a peak wavelength of excitation light is 600 nm or approximate thereto. In one or more embodiments, a peak wavelength of excitation light is 520 nm or approximate thereto. In one or more embodiments, ML material 12 requires an external light source to be placed into an excited state. In one or more embodiments, this light source is ambient or room lighting.

A plurality of assemblies 10 can be dispersed in medium 16 to form ML-containing medium 18. ML-containing medium 18 can be used as a sensing material that emits light in response to mechanical stress and deformation. It is preferred that the stress to be monitored is a dynamic stress instead of a static stress. Under static stress, the mechanoluminescent effect appears and then dissipates. However, under dynamic stress, the mechanoluminescent effect remains and gives a characterization of the dynamic stress. As described herein, ML-containing medium 18 can be useful for the application of monitoring structural health parameters of the substrate 20 to which it is applied.

Medium 16 is any medium that is capable of being applied onto a substrate 20. In one or more embodiments, medium 16 is a paintable medium and can be applied to substrate 20 through any known paint application technique. Medium 16 can be any liquid or liquefiable composition that, after application to substrate 20 in a thin layer, converts to form a solid film. In one or more embodiments, this formation of a solid film occurs by drying. Drying can refer to evaporation of a solvent, or can refer to oxidative cross-linking of a binder. This conversion can also be referred to as curing. In other embodiments, this conversion occurs as a chemical reaction, particularly as a polymerization.

Medium 16 comprises a binder or resin as the film-forming component of the medium. In one or more embodiments, the binder is selected from the group consisting of epoxy resin (also known as polyepoxides or epoxy polymers), optical epoxy resin, acrylic polymers, alkyd polymers, emulsion copolymers, and combinations thereof. In one or more embodiments, the formed solid film is optically transparent as to more fully reveal the mechanoluminescent effects imparted by ML material 12.

In one or more embodiments, medium 16 is an epoxy resin made from 1-chloro-2,3-epoxypropane and substituted phenols, such as bisphenol A. In one or more embodiments, medium 16 is an optical epoxy resin commercially available from Gougeon Brothers, Inc. (Bay City, Mich.) as the West System® brand epoxy. In one or more embodiments, an optical epoxy resin is West System® 105 Epoxy Resin® with a hardener additive of West System® 206 Slow Hardener®. 105 Epoxy Resin® is a resin that is a clear, pale yellow, low-viscosity liquid epoxy resin. 105 Epoxy Resin® is formulated for use with West System® hardeners, can be cured in a wide temperature range to form a high-strength solid with excellent moisture resistance, is further formulated without volatile solvents, and does not shrink after curing. 105 Epoxy Resin® has a relatively high flash point and no strong solvent odor, making it safer to work with than polyester or vinylester resins. Resin viscosity of 105 Epoxy Resin® is approximately 1000 centipoise (cp) at 72 degrees F. (22 degrees C.). 206 Slow Hardener® is a low-viscosity epoxy curing agent for particular use when extended working and cure time is needed or to provide adequate working time at higher temperatures. In one or more embodiments, 206 Slow Hardener® is combined with 105 Epoxy Resin® in a five-part resin to one-part hardener ratio, and the cured resin/hardener mixture yields a rigid, high-strength, moisture-resistant solid with excellent bonding and coating properties.

In one or more embodiments, medium 16 is an emulsion copolymer selected from the group consisting of styrene emulsion polymers, acrylic emulsion polymers, styrene/acrylic emulsion copolymers, and copolymers of ethenyl ethanoate (vinyl acetate) and a propenoate (acrylic) ester.

In one or more embodiments, medium 16 comprises a solvent for thinning the medium. The solvent can be either an organic solvent or water. A solvent is utilized to reduce the viscosity of medium 16 for improved application to substrate 20.

Medium 16 must possess a viscosity in a range such that a plurality of assemblies 10 will disperse within medium 16. If the viscosity of medium 16 is too high, assemblies 10 will not disperse. If the viscosity of medium 16 is too low, assemblies 10 will essentially precipitate from medium 16. Assemblies 10 can be provided in powder form and dispersed throughout medium 16. In one or more embodiments, a plurality of assemblies 10 are well dispersed in medium 16 as to form a generally consistent concentration of assemblies 10 throughout medium 16 as to form a generally consistent concentration of assemblies 10 throughout the solid film thereof once applied to substrate 20. In one or more embodiments, assemblies 10 can be dispersed in the paintable medium by using a magnetic stirrer.

ML-containing medium 18 can be characterized by the mass ratio of the aggregate mass of medium 16 to the aggregate mass of assemblies 10. In one or more embodiments, the mass ratio of the aggregate mass of medium 16 to the aggregate mass of assemblies 10 is from 1:1 or more to 3:1 or less. In other embodiments, the mass ratio of the aggregate mass of medium 16 to the aggregate mass of assemblies 10 is from 3:1 or more to 5:1 or less. In one or more embodiments, the mass ratio of the aggregate mass of medium 16 to the aggregate mass of assemblies 10 is 3:1 or approximate thereto. In one or more embodiments, the mass ratio of the aggregate mass of medium 16 to the aggregate mass of assemblies 10 is 2:1 or approximate thereto. In general, higher ratios show a higher sensitivity to stress.

In one or more embodiments, the formed solid film of ML-containing medium 18 is flexible as to be used on complex surfaces, such as curved surfaces, without cracking or becoming brittle after application. ML-containing medium 18 is capable of application to a surface through brush coating, spray paint, airspray, airless spray, roll coating, dip coating, and flow coating. Medium 18 can also be made as a thin film. In one or more embodiments, a thin film is applied directly on a substrate. In other embodiments, a thin film is prepared independently of the substrate and then the thin film is applied to the substrate. In one or more embodiments, a doctor blade is used to produce a thin film.

The formed solid film must maintain a hardness sufficient for transferring the mechanical force from the formed solid film to ML material 12. Mechanisms for the ML phenomena are best understood in the framework of a piezoelectrically induced detrapping model as understood by those skilled in the art. Therefore, it is important that the solid film is able to effectively transfer the stress to ML material 12.

The formed solid films can be employed for with non-destructive testing (NDT) analysis techniques. The details of NDT techniques are known to those skilled in the art. NDT can be used in all phases of a product's design and manufacture, including materials selection, research and development, assembly, quality control, and maintenance.

The formed solid films can also be employed for sensing and monitoring of structural health of the substrates 20 to which they are applied. They can be used for routine inspection of structures, particularly for safety critical structures such as infrastructure and aircraft. They can also be utilized for applications relating to bioengineering and biomechanics. One or more aspects of the formed solid film are provided by International Application No. PCT/US2014/054925, which is incorporated herein by reference.

The mechanoluminescence of a formed solid film can be measured both qualitatively and quantitatively. The qualitative measurement for mechanoluminescence would be for whether light is present. The quantitative measurement for mechanoluminescence would be how much light is present. Both qualitative and quantitative measurements can be done using images and image processing. Examples of devices that can be used for such measurements include cameras, photo multiplier tubes, and spectrometers. Image processing can be used for measuring relative light intensity. For example, after an image is taken of the mechanoluminescence of a solid film, the color of the pixels can be analyzed. For a black and white image, the amount of white or gray color in an image will allow for the analysis of the mechanoluminescence. Further, photo multiplier tubes can measure light intensity over time. Also, standard curves can be constructed for converting light emission into a quantitative measurement. In one or more embodiments, mechanoluminescence of a formed solid film is measured by an apparatus as disclosed in U.S. patent application Ser. No. 14/511,373, which is incorporated herein by reference.

Where a color change is utilized, a method of measuring color change can include the use of CIE color space. The CIE system characterizes colors by a luminance parameter and two color coordinates which specify the point on the chromaticity diagram. This system offers more precision in color measurement. A dried solid film can provide strain distribution information by the changes in color.

As said above, coating 14, 14′ at least partially coats ML material 12. As used herein, at least partially coats means that a coating material is present on at least some of the outer surface of ML material 12. This at least partial coating can take at least three forms: a coating material that forms a solid layer that surrounds ML material 12, as shown in FIG. 1; a coating material that forms a porous layer that surrounds ML material 12; and attaching a plurality of particles 14′ to the surface of ML material 12. Coating 14, 14′ provides one or more additional properties to the coated assembly 10, where additional can be said to mean in addition to the mechanoluminescence aspect provided by ML material 12.

In one or more embodiments, coating 14 is made from a compound that can be utilized as pigment. In one or more embodiments, coating 14 is made from titanium dioxide. The titanium dioxide coating can be either a solid shell coating of ML material 12 or a porous shell coating of ML material 12.

When coating 14 is made from a pigment compound, a dye material will be dispersed in medium 16 along with the plurality of assemblies 10. In one or more embodiments, the dye material is an organic dye species. An organic dye species can be selected from the group consisting of methylene blue, methyl orange, methyl red, Alizarin yellow R, Janus green, Metanil yellow, Gentian violet, and combinations thereof.

Since the dye material is present in these embodiments, when the associated solid film is formed on substrate 20, the dried solid film will have the visual color associated with dye material and the corresponding reflection wavelength thereof. Then, when the ML material 12 is subject to mechanical action, such as strain, ML material 12 will emit light. In one or more embodiments, ML material 12 emits ultraviolet light with a peak wavelength in the range of 380 nm or more to 420 nm or less. The light from the ML material 12 can be said to be generated by piezoelectric actions inside of ML material 12. The emitted light can then activate a photocatalytic chemical reaction with the coating 14 when coating 14 is made from a pigment. Where coating 12 is made from titanium dioxide, the light emission of the ML material 12 activates a photocatalytic chemical reaction with the titanium dioxide. In one or more embodiments, the photocatalytic chemical reaction is a photocatalytic degradation which results in the decoloration or bleaching of the color of the dye material. The decoloration can occur by oxidation of the dye material. In one or more embodiments, the color change of a dye material is from a non-white color to white. In one or more embodiments, the color change of a dye material is from white to a non-white color.

To effect a color change, the titanium dioxide adsorbs photons to generate electron-hole pairs. The electron can then move to the conduction band and migrate to the particle surface where a redox reaction occurs. The redox reaction results in dye degradation and color bleaching.

Further details of titanium dioxide and photocatalytic reactions are known to those skilled in the art. For example, further details may relate to the particular reaction details such as conduction band, valence band, and generation of free radicals

Where coating 14 is a porous layer, the porousness of the coating 14 can increase the chemical reaction rate by increasing the specific area interfaced between the coating 14 and the medium. This can be particularly advantageous when the medium contains a dye and the coating 14 is made from a pigment. In one or more embodiments, the exact porosity of coating 14 can be designed such that the rate of optical property changes can be controlled. In one or more embodiments, when coating 14 is a porous coating, it can be characterized by a void fraction. In one or more embodiments, the void fraction of coating 14 is from 30% to 80%. In one or more embodiments, the void fraction of coating 14 is from 30% to 60%. In one or more embodiments, the void fraction of coating 14 is 40% or approximate thereto.

Based on the above, when coating 14 is a pigment, and the associated solid film forms on substrate 20, the film will reveal strain and stress distributions of substrate 20 by changing colors. Thus, the solid film will give full-field visualization of non-uniform strain distributions by optical color changes. This may allow for the ability to perform rapid and frequent visual inspections for strain levels without the need for an associated data acquisition system. These solid films can essentially store the straining records over time by the various coloration changes and therefore may not need continuous monitoring of light emission as some mechanoluminescence sensors do.

In one or more embodiments, the amount or strength of a color change can reveal information about the amount or strength of a strain. A larger or stronger strain results in more electrons being released, which leads to a higher rate of chemical reaction. Thus, the larger or stronger strain thereby results in more color changes than a smaller or weaker strain region. In one or more embodiments, a larger or stronger strain results in a faster bleaching rate.

In one or more embodiments, coating 14′ can be made from magnetic structures that are attached to the surface of ML material 12. In one or more embodiments, magnetic structures can be magnetic nanostructures. In one or more embodiments, coating 14′ can include magnetic nanostructures. The magnetic nanostructures can be selected from the group consisting of iron, nickel, cobalt, Neodymium, their associated oxides, ferrite, Samarium-Cobalt, and combinations thereof. In one or more embodiments, coating 14 includes both a pigment and magnetic nanostructures.

Where magnetic structures are utilized in coating 14′, the dried solid film on substrate 20 can reveal direction sensitive strain. That is, the dried film can be said to be a direction sensitive sensing film. Currently developed mechanoluminescence sensors are only able to reveal light intensity, which is a scalar property. However, the strains of a substrate are a direction-sensitive tensor quantity. Thus, the present assemblies 10 can reveal more information about the strain on a substrate.

The magnetic structures will have mobility for alignment purposes when subjected to a certain magnetic field. In one or more embodiments, assemblies 10 having a coating 14′ comprising magnetic particles can be aligned in a strong magnetic field platform. As seen in FIG. 4, assemblies 10 can align in the direction of the H field. In one or more of these embodiments, the assemblies 10 can be cured in medium 16 in order to stabilize the assemblies 10 in a chained structure, generally indicated by the numeral 22. In one or more embodiments, the medium 16 is a low viscosity medium. Depending on the viscosity of medium 16, the intensity of the magnetic field can be adjusted to ensure proper alignment of the chained structures 22.

The alignment of an aligned chain 22 of ML assemblies 10 can allow a dried solid film containing such chain 22 to give full-field strain and deformation information in a specific direction. When a strain on a substrate includes forces in a direction parallel with the chain alignment, the dried solid film will emit higher luminescence than when the strain on a substrate includes forces in a direction transverse with the chain alignment. Said another way, when a chain 22 of assemblies 10 is aligned in the x-direction, a stress in the x-direction will result in stronger illumination of the dried film than when a stress in the y-direction is applied to the dried film. Without being limited to a particular theory, it is believed that this occurs because more of the ML assemblies 10 will be piezoelectrically excited to luminesce. It is further believed that the higher light intensity occurs because of the series of contacts with neighboring assemblies 10 in the direction of alignment.

One or more methods of coating mechanoluminescence materials can be selected from sol-gel methods and in-situ thermal decomposition methods. In one or more embodiments, a pigment coating, such as titanium dioxide, can be applied to a mechanoluminescence material by a sol-gel method. In one or more embodiments, a magnetic coating can be applied to a mechanoluminescence material by an in-situ thermal decomposition method.

Sol-gel methods generally include producing solid materials from small molecules. Sol-gel methods can involve conversion of monomers into a colloidal solution, i.e. the sol, that acts as the precursor for an integrated network, i.e. the gel, of either discrete particles or network polymers. Typical precursors are metal alkoxides.

One or more sol-gel methods can include a first step of combining an organometallic with an alcohol. The organometallic can be tetrabutyl titanate and the alcohol can be absolute ethanol and the volume to volume ratio of organometallic to alcohol can be 1:3 or approximate thereto. A next step can include adding a solution to the organometallic, alcohol combination. The solution can include an alcohol, an organic compound, an acid, and water. The alcohol can be absolute ethanol, the organic compound can be 2,4-pentanedione, and the acid can be nitrite acid. Steps of stirring and allowing the combination to react can also be employed. The step of allowing the combination to react will result in the formation of a sol. A suitable sol can be a titanium dioxide sol. A sol can then be combined with a mechanoluminescence material and subsequently stirred. Steps of separating the mechanoluminescence material by centrifuge, drying the mechanoluminescence material, and annealing the mechanoluminescence material can also be employed. A step of annealing can be employed at 500° C. for 1 hour with a heat rate of 5° C./min.

In-situ thermal decomposition methods generally include a chemical decomposition caused by heat. One or more in-situ thermal decomposition methods can include a first step of dispersing a mechanoluminescence material in a solvent. A suitable solvent is toluene and the dispersion of a mechanoluminescence material can be further aided by sonication. A next step can include combining a precursor with the solvent containing the mechanoluminescence material. A suitable precursor is an iron precursor such as iron pentacarbonyl. Other magnetic precursors can also be employed. Steps of stirring the combination and heating the combination can also be employed. A step of heating the combination can include heating the combination at least to the boiling point of the solvent. A step of heating the combination can include heating the combination at least to the decomposition temperature of the precursor. Where a decomposition temperature is reached, the precursor can decompose and form nucleation/nanoparticle growth on the surface of the mechanoluminescence material.

The present assemblies 10 can be used to visualize stress or crack distributions. In one or more embodiments, assemblies 10 can be used with a medium 16 that is flexible as to be used on curved surfaces as a paint sensor.

Embodiments of the present invention can include one or more methods of using a mechanoluminescence assembly 10. A method of using an assembly comprising a mechanoluminescence material and a coating can include one or more of the following steps: providing a medium comprising a mechanoluminescence assembly having a mechanoluminescence material coated with a coating material; applying the medium to a substrate; allowing the medium to form a solid film on the substrate; applying a mechanical force to the substrate to stress the substrate; measuring the mechanoluminescence of the solid film following the application of the mechanical force. A method of using an assembly can also include one or more of the following steps: providing a mechanoluminescence material; at least partially coating the mechanoluminescence material with a coating to form a mechanoluminescence assembly; dispersing a plurality of the mechanoluminescence assemblies within a medium that carries the plurality of assemblies; applying the medium to a substrate; allowing the medium to form a solid film on the substrate; and allowing the substrate to be stressed following the formation of the solid film. Methods of the present invention can further include the step of determining whether the substrate has undergone strain by analyzing whether the solid film has changed color. Methods of the present invention can further include the steps of subjecting a plurality of mechanoluminescence assemblies to a magnetic field having an H field and aligning the plurality of mechanoluminescence assemblies in the direction of the H field.

In light of the foregoing, it should be appreciated that the present invention significantly advances the art by providing improved mechanoluminescence material assemblies and associated methods of making and using. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A method of using a mechanoluminescence assembly to observe stress distributions of a stressed substrate comprising the steps of
providing a mechanoluminescence material;
at least partially coating the mechanoluminescence material with a coating to form a mechanoluminescence assembly;
dispersing a plurality of the mechanoluminescence assemblies within a medium that carries the plurality of assemblies;
applying the medium to a substrate;
allowing the medium to form a solid film on the substrate; and
allowing the substrate to be stressed following the formation of the solid film.

2. The method of claim 1, wherein the coating is titanium dioxide and the medium further comprises a dye.

3. The method of claim 2, further comprising the step of determining whether the substrate has undergone strain by analyzing whether the solid film has changed color.

4. The method of claim 2, wherein the dye is an organic dye species.

5. The method of claim 4, wherein the organic dye species is selected from the group consisting of methylene blue, methyl orange, methyl red, Alizarin yellow R, Janus green, Metanil yellow, Gentian violet, and combinations thereof.

6. The method of claim 1, wherein the coating is a plurality of magnetic nanoparticles attached to the surface of the mechanoluminescence material.

7. The method of claim 6, wherein the magnetic nanoparticles are selected from the group consisting of iron, nickel, cobalt, iron oxide, nickel oxide, cobalt oxide, and ferrite.

8. The method of claim 6, further comprising the steps of subjecting the plurality of mechanoluminescence assemblies to a magnetic field having an H field and aligning the plurality of mechanoluminescence assemblies in the direction of the H field.

9. A sensor for visualizing stress comprising a medium and a plurality of mechanoluminescence assemblies dispersed therein, each mechanoluminescence assembly comprising a mechanoluminescence material and a coating material, the mechanoluminescence material being at least partially coated with the coating material.

10. The sensor of claim 9, the medium containing the plurality of mechanoluminescence assemblies dispersed therein forming a dried solid film on a substrate.

11. The sensor of claim 9, the coating being titanium dioxide and the medium further comprising a dye.

12. The sensor of claim 11, the medium forming a dried film on a substrate and the medium capable of undergoing a color change when a strain is applied to the substrate.

13. The sensor of claim 12, the dye being an organic dye species.

14. The sensor of claim 13, the organic dye species being selected from the group consisting of methylene blue, methyl orange, methyl red, Alizarin yellow R, Janus green, Metanil yellow, Gentian violet, and combinations thereof.

15. The sensor of claim 9, the coating being a plurality of magnetic nanoparticles attached to the surface of the mechanoluminescence material.

16. The sensor of claim 15, the magnetic nanoparticles being selected from the group consisting of iron, nickel, cobalt, iron oxide, nickel oxide, cobalt oxide, and ferrite.

17. The sensor of claim 15, the medium forming a dried film on a substrate and the plurality of mechanoluminescence assemblies being alignable into a chained structure within the dried film, the chained structure being capable of having a direction of alignment that is parallel with an H field of a magnetic field.

18. A method of coating a mechanoluminescence material to be used for observing stress distributions of a stressed substrate comprising the steps of:
dispersing a mechanoluminescence material in a solvent;
combining a precursor with the solvent containing the mechanoluminescence material to form a combined mixture; and
heating the combined mixture to at least the decomposition temperature of the precursor to thereby form nucleation or nanoparticle growth on the surface of the mechanoluminescence material.

19. The method of claim 18, the solvent being toluene and the precursor being iron pentacarbonyl.

20. The method of claim 18, wherein the dispersion is performed by sonication, the method further comprising the step of heating the combined mixture to at least the boiling point of the solvent.
